(19) United States
(12) Patent Application Publication
(10) Pub. No.: US 2007/0007824 A1
(43) Pub. Date: Jan. 11, 2007

(54) DC uninterruptible power supply and computer device using the same

(75) Inventors: En-Li Chen, Taipei City (TW); Wei-Shi Sa, Taipei City (TW); Chun-Yen Yeh, Taipei City (TW)

Correspondence Address: BACON & THOMAS, PLLC, 625 SLATERS LANE, FOURTH FLOOR, ALEXANDRIA, VA, 22314, US

(73) Assignee: ASROCK INC., Taipei City (TW)

(21) Appl. No.: 11/436,668

(22) Filed: May 19, 2006

(30) Foreign Application Priority Data
Jul. 11, 2005 (TW) 094123367

(51) Int. Cl. H02J 9/00

(52) U.S. Cl. 307/66

(57) ABSTRACT

A DC uninterruptible power supply (DC UPS) is configured in a computer device that includes a power supply connected to an AC power source and a motherboard. The DC UPS is electrically connected between the power supply and the motherboard. Thus, when the power provided by the power supply is abnormal, the DC UPS can provide a set of DC powers to the motherboard and associated devices in the computer device.

### BACKGROUND OF THE INVENTION

1. Field of the Invention

The invention relates to an uninterruptible power supply (USP) and, more particularly, to a DC uninterruptible power supply and computer device using the same.

2. Description of Related Art

An uninterruptible power supply (UPS) is typically used to protect a computer system from system crash and data loss. FIG. 1 shows a schematic diagram of a typical uninterruptible power supply (UPS) 11. As shown in FIG. 1, the UPS 11 has an input terminal 111 connected to the utility power and an output 112 terminal 112 connected to the power supply 121 of a computer device 12.

FIG. 2 shows an interior block diagram of the UPS 11. In FIG. 2, the UPS 11 includes an AC-DC converter 115, a DC-AC converter 116, a DC-DC inverter 117 and a battery 118. When the utility power (an AC power) works normally, the battery 118 is charged and the AC-DC converter 115 converts the AC power to a DC power which is then converted by the DC-AC converter 116 into AC power for being outputted to the power supply 121 via the output terminal 112. When the utility power works abnormally, the battery 118 starts to provide a DC input to the DC-AC converter 116. The DC input provided by the battery 118 is first converted by the DC-DC inverter 117 and then sent to the DC-AC converter 116, thereby avoiding power interruption. The aforementioned UPS 11 can be an on-line UPS, an off-line UPS or a line-interactive UPS. However, such a UPS is a typical AC-type UPS, which requires a DC-AC converter, resulting in the problems of bulky volume and high cost. In addition, the UPS typically provides a single power output only that cannot be directly applied to a computer system that requires various power inputs. Therefore, it is desirable to provide an improved UPS to mitigate and/or obviate the aforementioned problems.

### SUMMARY OF THE INVENTION

An object of the invention is to provide a DC uninterruptible power supply and computer device using the same, which can prevent the computer device from system crash and data loss caused by an unstable or interrupted power supply.

Another object of the invention is to provide a DC uninterruptible power supply and computer device using the same, which can directly provide the computer device with various DC power supplies.

A further object of the invention is to provide a DC uninterruptible power supply and computer device using the same, which can provide a small-volume and high-efficiency DC uninterruptible power supply.

According to one aspect of the invention, a computer device is provided. The computer device includes a power supply, a motherboard and a DC uninterruptible power supply. The power supply is connected to an alternating current (AC) power source and provides a direct current (DC) power. The DC uninterruptible power supply having a battery is electrically connected to the power supply and the motherboard for receiving the DC power provided by the power supply to thereby charge the battery and providing a set of DC powers to the motherboard. When the power supply powers abnormally, the DC UPS uses the battery to provide the set of DC powers to the motherboard.

According to another aspect of the invention, a DC uninterruptible power supply is provided, which is implemented in a computer device including a power supply and a motherboard. The power supply is connected to an alternating current (AC) power source and provides a direct current (DC) power. The DC uninterruptible power supply includes a battery, a charger, a DC-DC inverter and a controller. The charger is electrically connected to the power supply and the battery for charging the battery. The DC-DC inverter is electrically connected to the battery and the motherboard for providing a set of DC powers to the motherboard. The controller is electrically connected to the power supply, the battery and the motherboard for controlling the DC-DC inverter to provide the set of DC powers to the motherboard when the power supply powers abnormally.

According to a further aspect of the invention, a DC uninterruptible power supply system is provided. The DC uninterruptible power supply system includes a power supply and a DC uninterruptible power supply. The power supply is electrically connected to an alternating current (AC) power source and a DC-applied device. The DC UPS is a DC-DC power supply and electrically connected to the power supply and the DC-applied device for providing a DC power to the DC-applied device when the power supply powers abnormally.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic diagram of a typical uninterruptible power supply (UPS);

FIG. 2 shows a block diagram of the interior of the typical UPS of FIG. 1;

FIG. 3 shows a block diagram of a direct current uninterruptible power supply implemented in a computer device according to a preferred embodiment of the invention;

FIG. 4 is schematic view illustrating a direct current uninterruptible power supply mounted in a computer device; and

FIG. 5 is a diagram of an application of a DC uninterruptible power supply according to the invention.

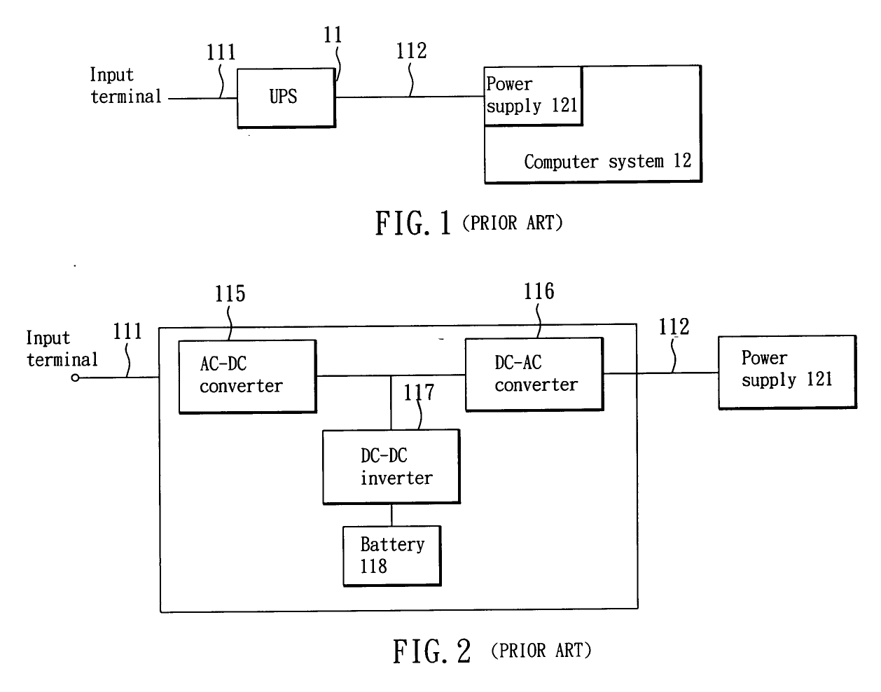

### DETAILED DESCRIPTION OF THE PREFERRED EMBODIMENT

The invention provides a DC uninterruptible power supply (DC UPS) implemented in a computer device. The computer device can be a desktop, barebone computer, server, network-attached storage (NAS) or Redundant Array of Independent Disks (RAID). The DC UPS is implemented between a power supply and a motherboard in the computer device for directly powering DC powers to the motherboard, a disk drive, a CD drive, and other internal devices in the computer device. The motherboard is a printed circuit board (PCB) implemented with a processor.

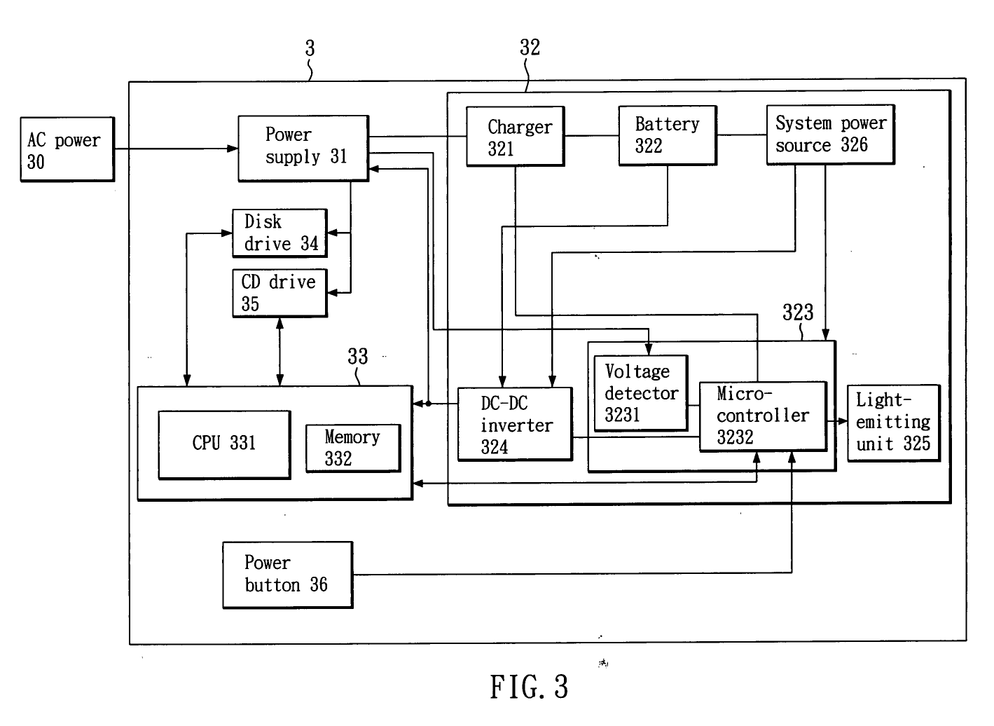

FIG. 3 shows a block diagram of a direct current uninterruptible power supply (DC UPS) 32 implemented in a computer device 3 according to a preferred embodiment of the invention. In FIG. 3, the computer device 3 includes a power supply 31, the DC UPS 32, a motherboard 33, a disk drive 34, a CD drive 35 and a power button 36. The DC UPS 32 includes a charger 321, a battery 322, a controller unit 323, a DC-DC inverter 324, a light-emitting unit 325 and a system power source 326. The motherboard 33 has a processor (CPU) 331 and a memory 332.

In this embodiment, the battery 322 can be a rechargeable battery such as a nickel hydrogen battery, a lithium ions cell, a nickel chromium battery, a lithium polymer battery, a lead acid battery, or the like.

The power supply 31 is implemented in the computer device 3 and connected to an external AC power 30, which is typically provided by the utility power. Namely, the power supply 31 is able to receive the AC power 30 via plugging an electric plug into a receptacle, and output a DC power. The power supply 31 is a typical computer power supply, and thus other additional power supplies with special specifications are not required.

The power supply 31 is also electrically connected to the DC UPS 32, the motherboard 33, the disk drive 34 and the CD drive 35. The power supply 31 is further electrically connected to the charger 321, a voltage detector 3231 and the DC-DC inverter 324 included in the DC UPS 32. Accordingly, the power supply 31 can provide a set of DC powers such as 12V voltage and/or 5V voltage to the drives 34 and 35. In addition, when the power supply 31 powers normally, the power supply 31 can provide the set of DC powers to the motherboard 33 through the DC UPS 32. Further, when the power supply 31 powers abnormally, the DC UPS 32 can provide the set of DC powers to the drives 34, 35, and other internal and external devices of the computer device 3 through the power supply 31, and directly to the motherboard 33. The DC UPS is described in detail hereinafter.

In the DC UPS 32, the charger 321 is electrically connected with the power supply 31, the battery 322 and the microcontroller 3232 of the controller unit 323. The battery 322 is electrically connected with the charger 321, the system power source 326 and the DC-DC inverter 324. The system power source 326 is electrically connected with the battery 322, the controller unit 323 and the DC-DC inverter 324. The DC-DC inverter 324 is electrically connected with the power supply 31, the motherboard 33, the controller unit 323 and the system power source 326. The controller unit 323 is electrically connected with the power supply 31, the charger 321, the DC-DC inverter 324, the light-emitting unit 325, the system power source 326 and the power button 36. The detector 3231 is electrically connected to the power supply 31, and the microcontroller 3232 is connected with the charger 321, the detector 3231, the DC-DC inverter 324, the light-emitting unit 325, the motherboard 33 and the power button 36.

In this embodiment, the detector 3231 detects voltages of +12V, +5V and +3.3V and a power normal signal PWR_OK provided by the power supply 31. When the detected voltages and the signal PWR_OK are normal, the microcontroller 3232 controls the charger 321 to charge the battery 322.

When one of the detected voltages or the signal PWR_OK is abnormal, for example, the voltage drops from +12V to 9V or the signal PWR_OK is changed from high potential to a low potential, the detector 3231 produces a detection enable signal to the microcontroller 3232. In this case, the battery 322 provides power to the system power source 326 and the DC-DC inverter 324, such that the system power source 326 can power the controller unit 323 and the DC-DC inverter 324 for operation. Meanwhile, based on the detection enable signal, the microcontroller 3232 controls the DC-DC inverter 324 to provide various power rails required for the computer device 3. The power rails include the voltages of +12V, +5V, +3.3V and +5 VSB (standby).

For example, the DC-DC inverter 324 provides one or more DC powers to the motherboard 33. The DC-DC inverter 324 also provides the DC power to the drives 34 and 35, and other internal devices of the computer device 3 through the power supply 31. In other embodiments, the DC-DC inverter 324 can provide a DC power directly to the drives 34 and 35.

In a conventional implementation, the power line of a power supply of the computer device (such as the power line of 20-pin or 24-pin connector) is directly connected to a motherboard to provide a DC power to the motherboard. In this embodiment, the power line of the power supply 31 is first connected to the connector of the DC UPS 32. In addition, the signal line (2-pin connector) PWRBTN_CHASSIS of the power button 36 is also connected to the DC UPS 32. The DC UPS 32 provides a power line having 20- or 24-pin connector and a signal line PWRBTN_MB having 2-pin connector for connecting to the motherboard 33. In this case, the DC-DC inverter 324 can provide one or more DC powers to the motherboard 33 through the power line having 20- or 24-pin connector, and use the signal line PWRBTN_MB to notify the motherboard 33 of entering into a sleep mode when the power supply 31 powers abnormally.

When the power supply 31 powers abnormally, the DC UPS 32 can use the detector 3231 of the controller unit 323 to determine whether or not the power supply 31 can power normally. When the DC UPS 32 determines that the power supply 31 cannot power normally, one or more DC powers are provided by the DC UPS 32 to the motherboard 33 and the disk drive 34, a sleep signal is sent by the microcontroller 3232 of the controller unit 323 to the motherboard 33 through the line having the 2-pin connector and connected to the motherboard 33, such that the processor 331 of the motherboard 33 can store the system use-associated data stored in the disk drive 34. Further, upon software settings, an operating system (OS) can automatically make the computer device 3 enter in the sleep mode when the sleep signal is sent to the motherboard 33.

Next, when the computer device 3 successfully enters in the sleep mode (i.e., the system use-associated data is stored in the dusk drive 34), the motherboard 33 produces a power-off signal to the microcontroller 3232 of the controller unit 323 of the DC UPS 32. The microcontroller 3232 reads the power-off signal, and accordingly controls the DC-DC inverter 324 not to output the DC powers and controls the light-emitting unit 325 lighting for a predetermined period of time. In this embodiment, the light-emitting unit 325 can consist of one or more light-emitting diodes (LEDs), and the predetermined period of time is ten minutes, i.e., the light-emitting unit 325 successively lights ten minutes after the computer device 3 enters the sleep mode for reminding the user about the current state of the computer device 3. In other embodiments, the light-emitting unit 325 can be implemented in the computer device 3, not in the DC UPS 32, and the predetermined period of time can be changed with use habits.

The power-off signal can be implemented by a power signal PS_ON#. Namely, when the computer device 3 does not enter in the sleep mode, the power signal PS_ON# is at a low potential. In this case, the microcontroller 3232 reads the power signal PS_ON# and accordingly allow the DC-DC inverter 324 to output the DC power. Conversely, the power signal PS_ON# is at a high potential when the computer device 3 enters in the sleep mode, and the microcontroller 3232 reads the power signal PS_ON# and accordingly controls the DC-DC inverter 324 not to output the DC power.

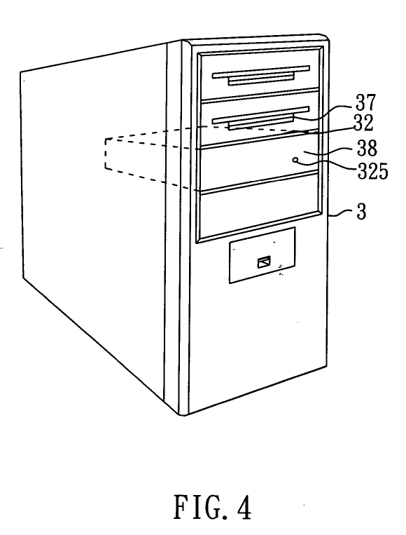

FIG. 4 shows a schematic diagram of the DC UPS 32 implemented in the computer device 3. The computer device 3 has a first expansion space 37 and a second expansion space 38. The DC UPS 32 is designed as a small-volume case suitably for being mounted in the space 37 or 38 of the computer device 3. For example, the first expansion space 37 can accommodate the drive 34 or 35 (not shown), and the second expansion space 38 can accommodate the DC UPS 32. In other embodiments, because the entire volume of the computer device 3, such as a barebone computer, may be smaller, the DC UPS 32 can be disposed on an appropriate location in the barebone computer to obtain an optimal mechanism design. In addition, the light-emitting unit 325 of the DC UPS 32 can be implemented on the exterior side of the DC UPS 32 such that a user can be reminded easily and conveniently by lighting the light-emitting unit 325

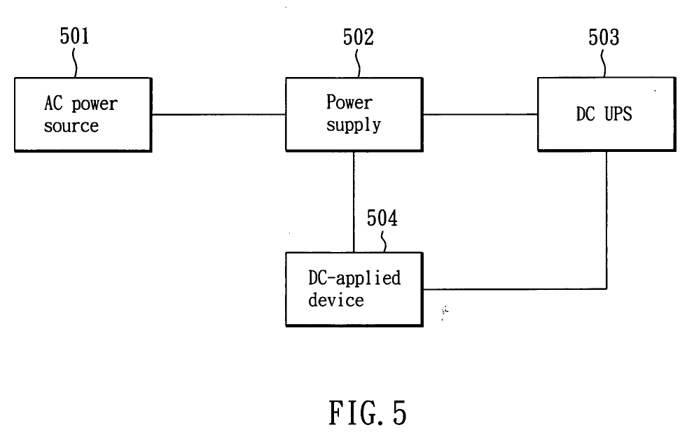

As cited, the DC UPS is implemented in the computer device and connected between the power supply and the motherboard, which is different from a typical DC UPS that is implemented outside a computer device. In addition, the DC UPS can maintain at a stable DC voltage when the AC power is abnormal, without the need of detecting an AC voltage or frequency. The charger can use the DC power provided by the power supply to charge the battery directly, without the need of connecting to the AC power. Further, the DC UPS receives the DC power provided by the power supply and provides various power rails required for the computer device. Accordingly, the DC UPS does not need the AC-DC converter and the DC-AC converter as cited in the prior art to thereby have the smaller volume and the lower manufacturing cost. The DC UPS is not limited to the cited above, and the alternates can be implemented by those skilled in the art. An example is given in FIG. 5, which shows a system structure of DC UPS. The structure includes an AC power source 501, a power supply 502, a DC UPS 503 and a DC-applied device 504. The AC power source 501 can be a utility power source such as an 110V, 60 Hz AC power source or a 220V, 50 Hz AC power source, depending on the actual requirement. The power supply 502 is electrically connected to the AC power source 501 to thereby receive an AC power and output a DC power to the DC-applied device 504 such as a disk drive, CD drive or motherboard. However, the DC-applied device 504 can be an external CD drive, not limited to a device in the computer device. The DC UPS 503 is electrically connected to the power supply 502. In another embodiment, the DC UPS 503 is further electrically connected to the DC-applied device 504. It is noted that the DC UPS 503 is a DC-DC power supply, i.e., DC input and DC output. When the power supply 502 works normally, the DC UPS 503 receives the DC power provided by the power supply 502 for charging. When the power supply 502 works abnormally, the DC UPS 503 provides the DC power to the DC-applied device 504.

Although the present invention has been explained in relation to its preferred embodiment, it is to be understood that many other possible modifications and variations can be made without departing from the spirit and scope of the invention as hereinafter claimed.

What is claimed is:

1. A computer device, comprising:
a power supply, which is connected to an alternating current (AC) power source and provides a direct current (DC) power;
a motherboard; and
a DC uninterruptible power supply (UPS) having a battery, the DC UPS being electrically connected to the power supply and the motherboard to thereby receive the DC power provided by the power supply to charge the battery, the DC UPS providing at least one set of DC powers to the motherboard, wherein, when the power supply powers abnormally, the DC UPS uses the battery to provide the set of DC powers to the motherboard.

2. The computer device as claimed in claim 1, wherein the DC UPS further comprises a charger to receive the DC power and charge the battery.

3. The computer device as claimed in claim 1, wherein the DC UPS further comprises a controller unit having a voltage detector electrically connected to the power supply for detecting whether the power supply is normal or abnormal.

4. The computer device as claimed in claim 1, wherein the DC UPS further comprises a light-emitting unit and a controller unit having a microcontroller electrically connected to the light-emitting unit, and the microcontroller controls the light-emitting unit to light for a predetermined period of time when the DC UPS provides the set of DC powers to the motherboard and the computer device enters in a sleep mode.

5. The computer device as claimed in claim 1, wherein the DC UPS further comprises a charger and a controller unit electrically connected to the power supply and the charger and having a microcontroller to control the charger to charge the battery.

6. The computer device as claimed in claim 1, wherein the DC UPS further comprises a charger, a DC-DC inverter and a controller unit in an arrangement that the charger is electrically connected to the power supply and the battery, the DC-DC inverter is electrically connected to the motherboard, and the controller unit is electrically connected to the power supply, the charger and the DC-DC inverter.

7. The computer device as claimed in claim 1, wherein the set of DC powers comprises three operating voltages of +12V, +5V, +3.3V, and one-standby voltage of +5V.

8. The computer device as claimed in claim 1, wherein the DC UPS is implement in an expansion space of the computer device.

9. The computer device as claimed in claim 8, wherein the expansion space is capable of accommodating a CD drive.

10. A direct current uninterruptible power supply (DC UPS) implemented in a computer device comprising a power supply and a motherboard, wherein the power supply is connected to an alternating current (AC) power source and provides a DC power, the DC UPS comprising:
a battery;
a charger, which is electrically connected to the power supply of the computer device and the battery for charging the battery;
a DC-DC inverter, which is electrically connected to the battery and the motherboard for providing a set of DC powers to the motherboard; and
a controller unit, which is electrically connected to the power supply, the charger and the DC-DC inverter for controlling the DC-DC inverter to provide the set of DC powers to the motherboard when the power supply powers abnormally.

11. The DC UPS as claimed in claim 10, wherein the controller unit comprises a voltage detector electrically connected to the power supply for detecting whether the power supply normal or abnormal.

12. The DC UPS as claimed in claim 10, further comprising a light-emitting unit electrically connected to a microcontroller included in the controller unit, wherein the microcontroller controls the light-emitting unit to light for a predetermined period of time when the DC UPS provides the set of DC powers to the motherboard and the computer device enters in a sleep mode.

13. The DC UPS as claimed in claim 10, wherein the controller unit comprises a microcontroller to control the charger to charge the battery.

14. The DC UPS as claimed in claim 10, wherein the set of DC powers comprises three operating voltages of +12V, +5V, +3.3V, and one standby voltage of +5V.

15. The DC UPS as claimed in claim 10, wherein the computer device comprises an expansion space, and the DC UPS is implement in the expansion space.

16. The DC UPS as claimed in claim 15, wherein the expansion space is capable of accommodating a CD drive.

17. A direct current uninterruptible power supply (DC UPS) system, comprising:
a power supply, which is connected to an AC power source and electrically connected to a DC-applied device; and
a DC UPS, which is a DC-DC power supply and electrically connected to the power supply and the DC-applied device, wherein the DC UPS provides a DC power to the DC-applied device when the power supply powers abnormally.

18. The DC UPS system as claimed in claim 17, wherein the DC-applied device is a disk drive.

19. The DC UPS system as claimed in claim 17, wherein the DC-applied device is an external CD driver.

20. The DC UPS system as claimed in claim 17, wherein the DC-applied device is a motherboard.
